(19) United States
(12) Patent Application Publication
(10) Pub. No.: US 2007/0156713 A1
(43) Pub. Date: Jul. 5, 2007

(54) Database schema for hosting prepaid and subscription information

(75) Inventors: Zeyong Xu, Issaquah, WA (US); Curt A. Steeb, Redmond, WA (US); Jeffrey Alan Herold, Bothell, WA (US); Gokul P. Thirumalai, Bellevue, WA (US); Minghui Gao, Redmond, WA (US); Munisamy Prabu, Issaquah, WA (US); Muhsin Demirbag, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/320,368

(22) Filed: Dec. 27, 2005

(51) Int. Cl. G06F 7/00

(52) U.S. Cl. 707/100

(57) ABSTRACT

Linked databases including a core database and a distribution database support provisioning for computers in pay-per-use and subscription business models. The core database is well removed from front-end processing and includes job, device and bootstrap tables. The distribution database includes tables for packet distribution and logging and is near the front-end processing blocks. The core database is well protected from attack, while the more volatile data in the distribution database is available with low latency. Performance is maintained while reducing the surface area exposed to external attack.

### BACKGROUND

Databases that support on-line transactions must be designed to maintain high speed but also to have a high resistance to attack. Placing the database closer to the front, i.e. closer to the network interface optimizes the speed by reducing delays. However, placing the database closer to the front reduces the number of points that can be interposed to mitigate an attack.

### SUMMARY

A pay-per-use or subscription product, device, peripheral, software or service may be required to periodically purchase usage minutes or renew a subscription for continued operation. Widespread deployment of such products and services may require substantial resources to support deployment and provisioning. By placing a main database well back in the provisioning system architecture, several layers of protection can be afforded the database. A thin database with data replicated from the main database may be placed close to the front end distribution processes to support fast transaction processing and a reduced footprint for attack. These two databases, or data structures linked by a communication mechanism, may hold data for initializing, maintaining, and provisioning prepaid and subscription products, services, peripherals, software and the like.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a simplified and representative block diagram of a provisioning system for prepaid and subscription-based computers;

FIG. 4 is a block diagram of a database layout used for prepaid and subscription information; and

FIG. 5 is a block diagram of a database layout used in conjunction with the database layout of FIG. 4.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

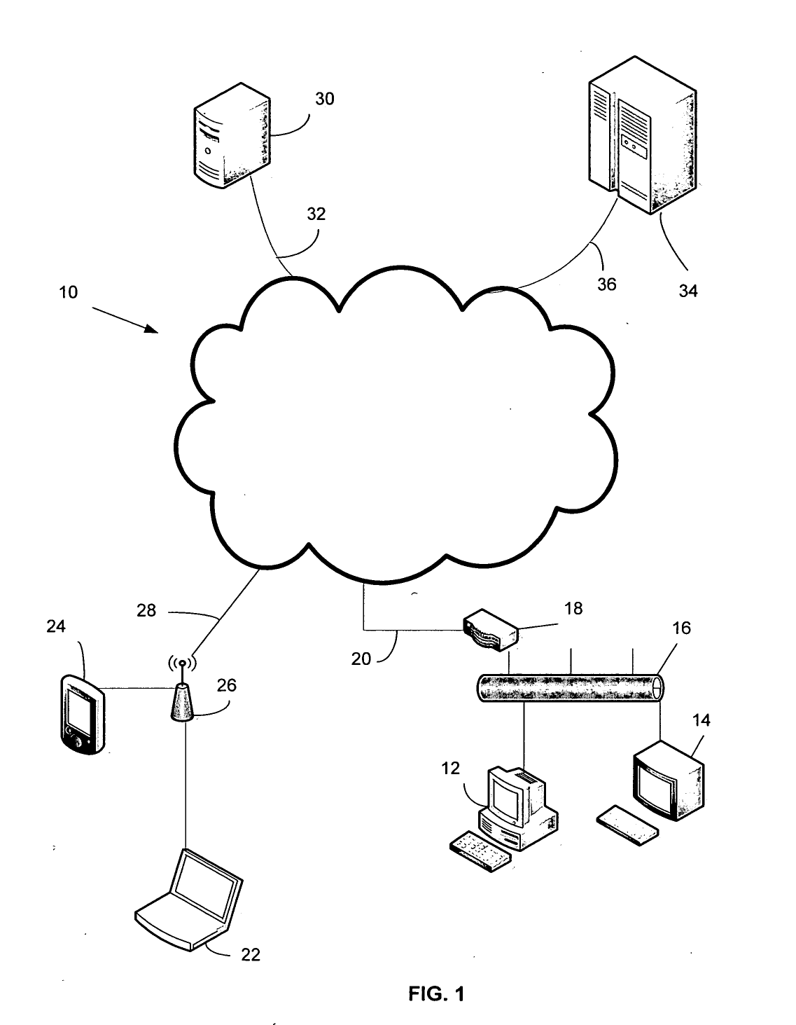

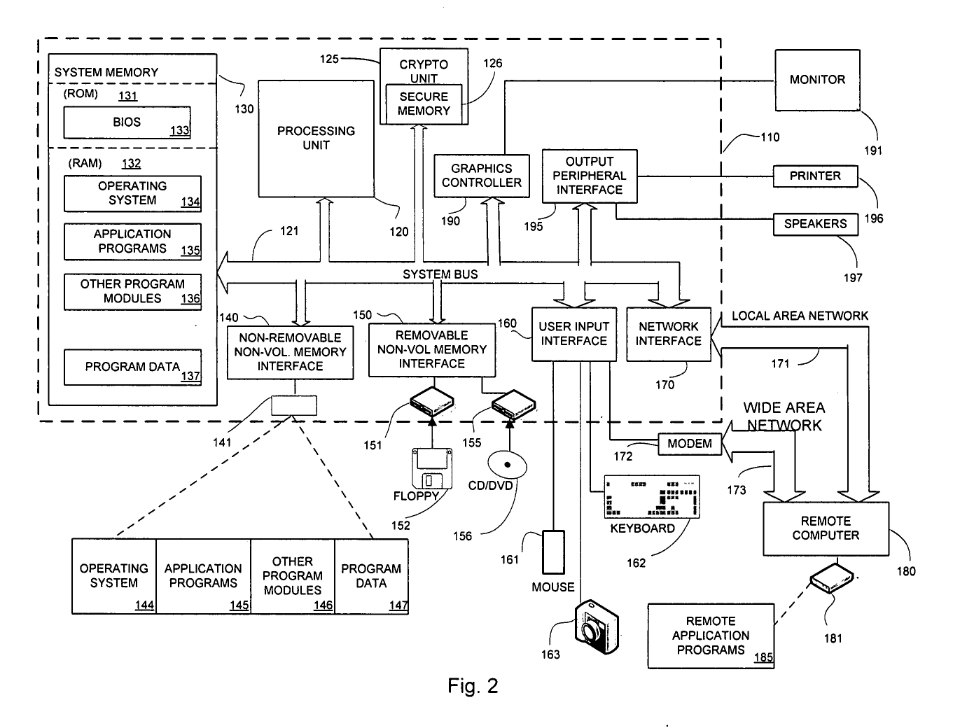

FIGS. 1 and 2 provide a structural basis for the network and computational platforms related to the instant disclosure.

FIG. 1 illustrates a network 10. The network 10 may be the Internet, a virtual private network (VPN), or any other network that allows one or more computers, communication devices, databases, processes, peer-to-peer network endpoints, etc., to be communicatively connected to each other. The network 10 may be connected to a personal computer 12, and a computer terminal 14 via an Ethernet 16 and a router 18, and a landline 20. The Ethernet 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163 , such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated-data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

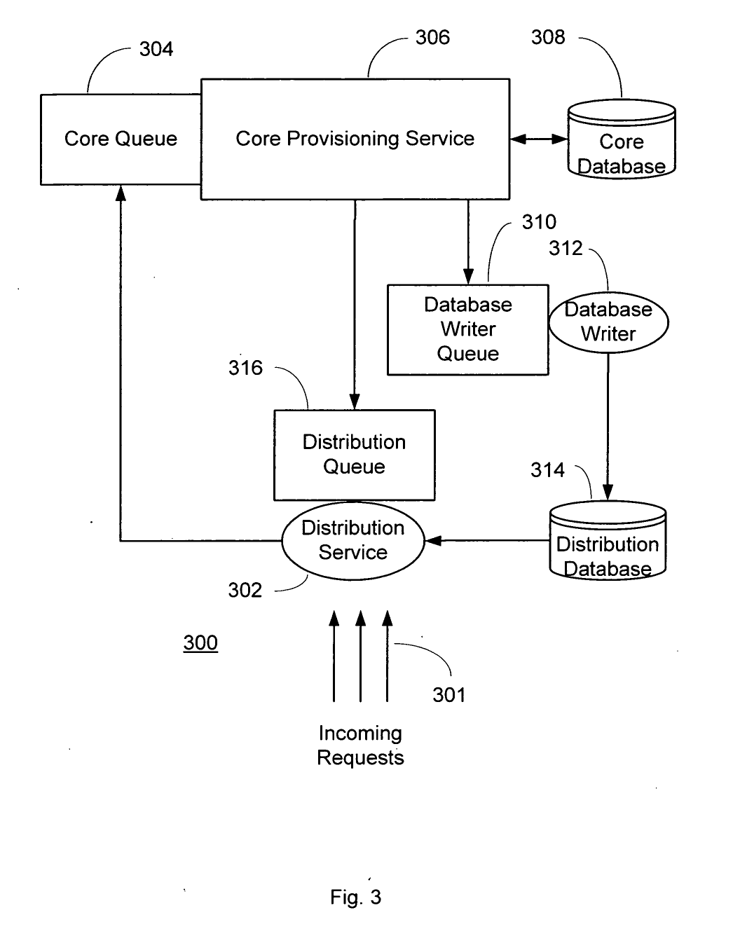

FIG. 3 is block diagram of a provisioning system 300 for prepaid and subscription-based computers. Incoming requests are processed by a distribution service 302. Requests are placed in a core queue 304 for processing by the core provisioning service 306. The core database 308 is the main database for servicing initial provisioning as well as subsequent subscription or pay-per-use requests. A database writer queue 310 may stage updates to the database writer 312 for maintaining the distribution database 314. The distribution database 314 may be used by the distribution queue 316 and the distribution service 302 to fulfill the incoming requests 301. As described below, the distribution database reflects data in the core database 308 to support timely access to data while providing less surface area for attack.

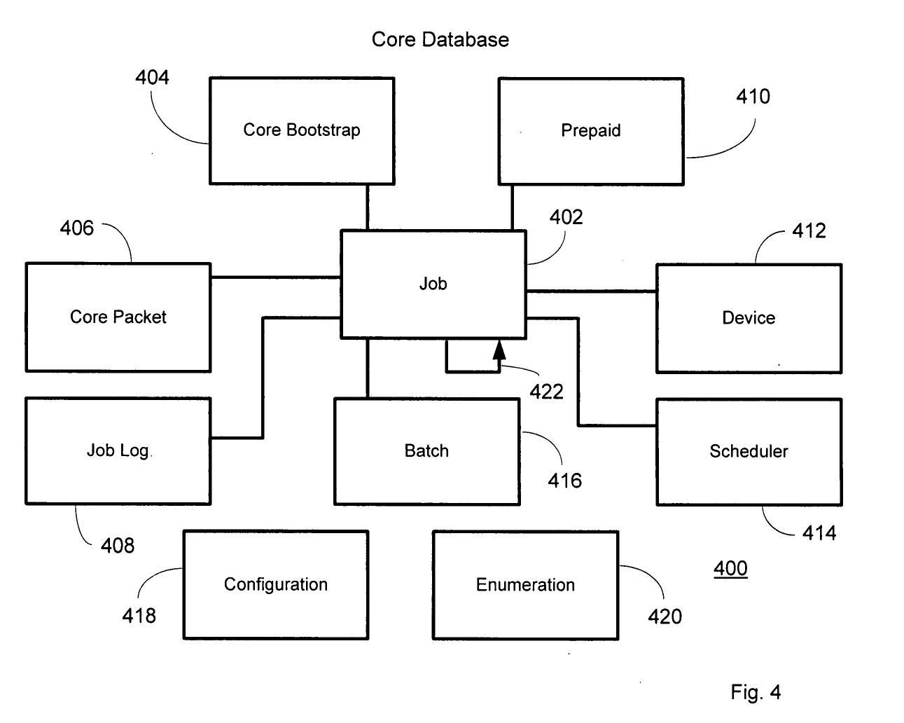

FIG. 4 is a block diagram showing the structure of the core database 400. A series of tables support the central job table 402. A core bootstrap table 404, a core packet table 406, a job log table 408, a prepaid table 410, a device table 412, a scheduler table 414, and a batch table 416 are all tied to the job table 402 and supported by common key fields, such as JobID and DeviceID. Support tables include a configuration table 418 and an enumeration table 420. The job table 402 is self-referencing 422, allowing an n-deep hierarchy. Each of the tables is discussed below.

Table 1 illustrates one possible layout of the job table 402. The job table 402 may store common job data that is created based on message requests. It may be used to track the status of a job. Job table records are designed to be permanent.

TABLE 1
Core Database—Job

| Column Name | Data Type | Length | Allow Nulls |
|---|---|---|---|
| JobID | bigint | 8 | |
| ParentJobID | bigint | 8 | X |
| DeviceID | Int | 4 | X |
| Type | Int | 4 | |
| Status | Int | 4 | |
| Data | Ntext | 16 | X |
| Requester | nvarchar | 50 | X |

The JobID may identify a particular activity through the life of the activity, for example, renewing a subscription. When the JobID relates to a previous activity, the ParentID field may be used to identify the relationship. The DeviceID may link to the DeviceID in the Device table 412. The Type field may indicate the nature of the job, such as batch or packet. The Status field in the Job table may hold the status of the Job, such as created, succeeded, or failed. The Data field may be the XML message request to create the job. The Requester may be the identifier of the requesting entity.

Table 2 illustrates one possible layout of the prepaid table 410. The prepaid table 410 may store prepaid job data. It may be used to create a prepaid packet. The prepaid table records may be designed to be permanent.

TABLE 2
Core Database—Prepaid

| Column Name | Data Type | Length | Allow Nulls |
|---|---|---|---|
| JobID | bigint | 8 | |
| TrackingGuid | uniqueidentifier | 16 | |
| PUID | nvarchar | 17 | |
| Points | Int | 4 | |
| Minutes | Int | 4 | |

The JobID may link to the JobID of the Job table. The TrackingGUID may be a global unique identifier that is created by the client device when making a prepaid payment request. The PUID may be the user passport ID. Points and Minutes may be the value fields of the request. Both points and minutes may be purchased with currency, i.e. a scratch card, or may be redeemed by coupons, or in exchange for paid activities such as viewing advertisements.

Table 3 illustrates one possible layout of the bootstrap table 404. The bootstrap table 404 may store bootstrap job data. It may be used to do device bootstrapping. The bootstrap table records may be designed to be permanent.

TABLE 3
Core Database—Bootstrap

| Column Name | Data Type | Length | Allow Nulls |
|---|---|---|---|
| JobID | bigint | 8 | |
| DownloadCount | Int | 4 | |

The JobID may link to the JobID of the Job table. The DownloadCount may maintain the number of attempts to deliver bootstrap data.

Table 4 may illustrate one possible layout of the packet table 406. The packet table 406 may store the packet job data. It may be used to track a provisioning packet's status. The packet table records may be designed to be permanent.

TABLE 4
Core Database—Packet

| Column Name | Data Type | Length | Allow Nulls |
|---|---|---|---|
| JobID | bigint | 8 | |
| SequenceNumber | Int | 4 | |
| DownloadCount | Int | 4 | |

The JobID may link to the JobID of the Job table. The sequence number may be a number given to a transaction to help prevent replay attacks. The sequence number may be increased by one for each transaction. The download count may be the number of attempts made to deliver a requested packet.

Table 5 may illustrate one possible layout of the device table 412. The device table 412 may store device data that is added during the device registration and bootstrap request processes. The device name may be unique, if not globally unique, unique within the administrative scheme of the business. The device table records may be used to identify the device and track the device status. Device table records may be designed to be permanent.

TABLE 5
Core Database—Device

| Column Name | Data Type | Length | Allow Nulls |
|---|---|---|---|
| DeviceID | Int | 4 | |
| Name | nvarchar | 50 | |
| InitKey | nchar | 25 | |
| HWID | nvarchar | 50 | X |
| UPID | nchar | 26 | X |
| LSN | Int | 4 | |
| Type | Int | 4 | |
| TotalMinutes | Int | 4 | |
| Status | Int | 4 | |

The DeviceID may link to the DeviceID of the Job table. The Name may be the logical device name assigned by the partner or underwriter associated with the device. The InitKey may be a registration key for use in initializing a computer, device, or service on the system. The HWID may be a device specific identifier, often created by the device manufacturer. The UPID may be a product identifier that corresponds to the type of service (e.g. prepaid or subscription) and other terms. The HWID and the UPID may uniquely identify the device. The LSN may be the last sequence number used for a transaction. The Type may identify the offer category, for example, pre-paid or subscription. TotalMinutes may be the total usage minutes purchased and granted over the life of the device. Status may hold data about the device status and may include created, active, disabled.

Table 6 may illustrate one possible layout of the job log table 408. The job log table 408 may log all activities relating to a job. The job log table records may be designed to be permanent.

TABLE 6
Core Database—JobLog

| Column Name | Data Type | Length | Allow Nulls |
|---|---|---|---|
| LogID | bigint | 8 | |
| JobID | bigint | 8 | |
| Type | Int | 4 | |
| Message | Ntext | 16 | X |
| LogDate | datetime | 8 | |

The JobID may link to the JobID of the Job table. The LogID may be an identifier of a log entry. The Type may be a log entry type and may include: job created, job in progress, job succeeded, device updated, etc. Message may be a string of the log text or related data. LogDate may be the date/time of the log entry.

Table 7 may illustrate one possible layout of the batch table 416. The batch table 416 may store the batch job data. It may be used to track a batch request in the subscription model. The batch table records may be designed to be permanent.

TABLE 7
Core Database—Batch

| Column Name | Data Type | Length | Allow Nulls |
|---|---|---|---|
| JobID | bigint | 8 | |
| Name | nvarchar | 50 | |
| ItemCount | Int | 4 | |
| PartnerID | nchar | 5 | |
| SendUrl | nvarchar | 256 | |

The JobID may link to the JobID of the Job table. The Name, as above, may be the logical device name assigned by the partner or underwriter associated with the device. ItemCount may be the total number of requests included in the batch. The PartnerID is an identifier associated with the business partner who supplies or underwrites a particular hardware, software, system or service covered by the prepaid or subscription plan. The SendURL may be a callback uniform record locator, or equivalent endpoint address, of the batch request.

Table 8 may illustrate one possible layout of the scheduler table 414. The scheduler table 414 may store the subscription scheduler 414 job data. It may be used to do the subscription packet scheduling. The scheduler table records may be designed to be permanent.

TABLE 8
Core Database—Scheduler

| Column Name | Data Type | Length | Allow Nulls |
|---|---|---|---|
| JobID | bigint | 8 | |
| StartDate | datetime | 8 | |
| EndDate | datetime | 8 | |
| NextDate | datetime | 8 | |

The JobID may link to the JobIDof the Job table. StartDate may be the date to start to create the requested packet by the scheduler 414. EndDate may be the date to stop packet creation by the scheduler. NextDate may be the date for the scheduler to create the next packet.

Table 9 may illustrate one possible layout of the configuration table 418. The configuration table 418 may predefine all of the name-value pairs used to configure the server hosting the database, such as server 30 of FIG. 1. This may include: MaxCertDownloadCount, MaxPacketDownloadCount, EnforcementLevel, GracePeriodinMinutes, PreProcessPeriodInDays, EnforcementPeriod, and EnforcementPeriodTimeUnit.

TABLE 9
Core Database—Configuration

| Column Name | Data Type | Length | Allow Nulls |
|---|---|---|---|
| ID | Int | 4 | |
| NameSpace | nvarchar | 25 | |
| Name | nvarchar | 50 | |
| Setting | Ntext | 16 | |

Table 10 may illustrate one possible layout of the Enumeration table 420. The enumeration table 420 may predefine all of the enumerable codes for the type and status values.

TABLE 10
Core Database—Enumeration

| Column Name | Data Type | Length | Allow Nulls |
|---|---|---|---|
| Code | int | 4 | |
| NameSpace | nvarchar | 25 | |
| Name | nvarchar | 25 | |
| Description | nvarchar | 256 | |

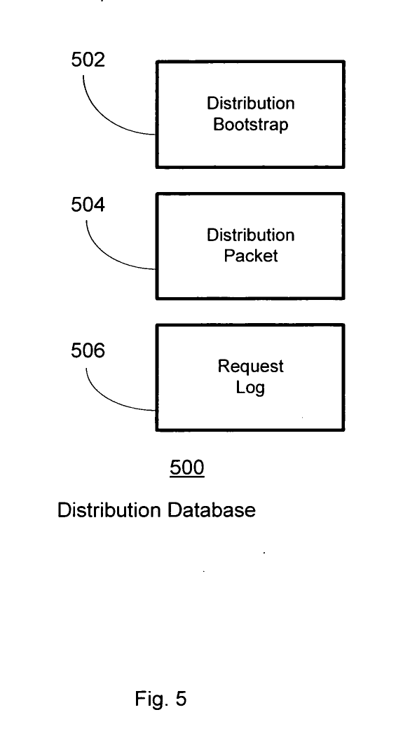

FIG. 5 is a block diagram of one example of the distribution database 500. The distribution database 500 may include a bootstrap table 502 that is separate in function and record layout from the core database bootstrap table 404. The distribution database 500 may also include a distribution packet table 504 and a request log table 506. Each of the tables is discussed further below.

Table 11 illustrates one possible the layout of the bootstrap table 502. The bootstrap table 502 may store the bootstrap data that is added by the core provisioning service during device registration. When the bootstrapping process is completed, the corresponding records may be removed by the core provisioning service.

TABLE 11
Distribution Database—Distribution Bootstrap

| Column Name | Data Type | Length | Allow Nulls |
|---|---|---|---|
| JobID | bigint | 8 | |
| InitKey | nchar | 25 | |
| HWID | nvarchar | 50 | |

The JobIDmay link to the JobID of the Job table. The InitKey, as above, may be a registration key for use in initializing a computer, device, or service on the system. The HWID may be a device specific identifier, often created by the device manufacturer.

Table 12 may illustrate one possible layout of the distribution packet table 504. The distribution packet table 504 may store the packets that are generated by the core provisioning service during packet generation. When a packet is downloaded by the client PC successfully, the record may be removed by the core provisioning service. Also, if a packet's download request count is greater than the max download count, the packet may be deleted by the stored procedure.

TABLE 12
Distribution Database—Distribution Packet

| Column Name | Data Type | Length | Allow Nulls |
|---|---|---|---|
| JobID | bigint | 8 | |
| HWID | nvarchar | 50 | |
| SequenceNumber | int | 4 | |
| Data | ntext | 16 | |
| DownloadCount | int | 4 | |
| MaxDownloadCount | int | 4 | |

The JobID may link to the JobID of the Job table. The HWID may be a device specific identifier, often created by the device manufacturer. The SequenceNumber may be the transaction specific identifier. The Data may be the XML message content for the packet. The DownloadCount may be the number attempts made to deliver the packet. The MaxDownloadCount may be the number of download attempts allowed before an event is raised and the attempted packet download is abandoned.

Table 13 may illustrate one possible layout of the request log table 506. The request log table may log all web requests made by clients. The request types include:

TABLE 13
Distribution Database—Request Log

| Column Name | Data Type | Length | Allow Nulls |
|---|---|---|---|
| LogID | bigint | 8 | |
| HWID | nvarchar | 50 | |
| ClientIP | nvarchar | 15 | |
| Type | nvarchar | 25 | |
| Message | ntext | 256 | |
| LogDate | datetime | 8 | |

The LogID may be the number of the log entry. The HWID may be a device specific identifier, often created by the device manufacturer. ClientIP may be the IP or other endpoint address of the client. The Type may include Certificate Request, Certificate Acknowledgement, Packet Request, and Packet Acknowledgement. Message may be the contents of the request. LogDate may be the date/time of the log entry.

For both databases and the tables listed above, the data types may be generally selected from types well known in the art, for example, an “int” may be a four byte integer value, a “bigint” may be an 8 byte integer, “ntext” may be mixed character text, for example, Unicode text, and an “nvarchar” may be a character string of the length in bytes indicated in the corresponding length entry. When a field is marked to “allow nulls” that marking may indicate that a null value is acceptable, and those fields not so marked are expected to have legal values.

The two databases accomplish the goal of providing robust and extensible support for pay-per-use and subscription use business models, particularly with respect to subsidized computer business. The core database may be well behind the front end processing while more volatile data in the distribution database may be easily accessible to more real-time activities such as packet acknowledgements. A more complete discussion of the provisioning process may be found in co-pending U.S. patent application Ser. No. 10/989,122.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. At least one computer-readable medium on at least one computer storing a linked data structure for storing information corresponding to paid use computer operation and provisioning comprising:
a distribution database comprising a request log table including LogID data, the hardware ID data, clientIP data, the type data, message data, and logdate data; and
a core database linked to the distribution database and comprising a device table including the deviceID data, name data, InitKey data, universal product identifier (UPID) data, LSN data, the type data, TotalMinutes data, and Status data.

2. The at least one computer-readable medium on at least one computer storing the linked data structure of claim 1, wherein the core database further comprises a job table including parentJobID data, deviceID data, text data, and requester data.

3. The at least one computer-readable medium on at least one computer storing the linked data structure of claim 2, wherein the core database further comprises a job table including the jobid data, type data, and status data.

4. The at least one computer-readable medium on at least one computer storing the linked data structure of claim 1, wherein the core database further comprises a prepaid table including the jobID, trackingGuid data, passport identifier data (PUID) data, and at least one of point data and minute data.

5. The at least one computer-readable medium on at least one computer storing the linked data structure of claim 1, wherein the core database further comprises a bootstrap table including the jobID and DownloadCount data.

6. The at least one computer-readable medium on at least one computer storing the linked data structure of claim 1, wherein the core database further comprises a packet table including the jobID, SequenceNumber data, and DownloadCount data.

7. The at least one computer-readable medium on at least one computer storing the linked data structure of claim 1, wherein the core database further comprises a JobLog table including the JobID data, LogID data, type data, message data, and LogDate data.

8. The at least one computer-readable medium on at least one computer storing the linked data structure of claim 1, wherein the core database further comprises a batch table including the JobIDdata, name data, ItemCount data, PartnerID data, and SendURL data.

9. The at least one computer-readable medium on at least one computer storing the linked data structure of claim 1, wherein the core database further comprises a scheduler table including the JobID data, StartDate data, EndDate data and NextDate data.

10. The at least one computer-readable medium on at least one computer storing the linked data structure of claim 1, wherein the core database further comprises a configuration table including ID data, NameSpace data, Name data, and Setting data.

11. The at least one computer-readable medium on at least one computer storing the linked data structure of claim 1, wherein the core database further comprises an Enumeration table including Code data, NameSpace data, Name data, and Description data.

12. The at least one computer-readable medium on at least one computer storing the linked data structure of claim 1, wherein the distribution database further comprises a distribution packet table including the JobIDdata, the hardware ID data, sequence number data, download count data, and MaxDownloadCount data.

13. The at least one computer-readable medium on at least one computer storing the linked data structure of claim 1, wherein the distribution database further comprises a distribution bootstrap table including JobID data, Initkey data and hardware ID data.

14. A data structure supporting pay-per-use and subscription business models comprising a Job table, a prepaid table, a bootstrap table, a packet table, a device table, a JobLog table, a batch table, a scheduler table, a configuration table, and an enumeration table.

15. The data structure of claim 14, wherein the device table comprises fields for deviceID data, name data, InitKey data, universal product identifier (UPID) data, LSN data, the type data, TotalMinutes data, and Status data.

16. The data structure of claim 14, wherein the batch table comprises fields for JobID data, name data, ItemCount data, PartnerID data, and SendURL data.

17. The data structure of claim 14, wherein the scheduler table comprises fields for JobID data, StartDate data, EndDate data and NextDate data.

18. The data structure of claim 14, wherein the Job table comprises fields for parent JobID data, deviceED data, text data, and requester data.

19. A data structure supporting pay-per-use and subscription business models comprising a distribution bootstrap table, distribution packet table, and a request log table.

20. The data structure of claim 19 wherein the request log table comprises fields for LogID data, the hardware ID data, clientIP data, the type data, message data, and logdate data.
